(19) United States
(12) Patent Application Publication
(10) Pub. No.: US 2025/0106170 A1
(43) Pub. Date: Mar. 27, 2025

(54) AUTOMATED ORDERING OF SERVICE IN SERVICE CHAIN FOR SOFTWARE-DEFINED WIDE AREA NETWORKS

(71) Applicant: Cisco Technology, Inc., San Jose, CA (US)

(72) Inventors: Avinash Shah, Pleasanton, CA (US); Pritam Baruah, Fremont, CA (US); Jai Prakash Agrawal, Bilaspur (IN); Amjad Inamdar, Karnataka (IN)

(21) Appl. No.: 18/472,052

(22) Filed: Sep. 21, 2023

(51) Int. Cl. H04L 47/34; H04L 41/14

(52) U.S. Cl. CPC H04L 47/34; H04L 41/145

(57) ABSTRACT

Disclosed are systems, apparatuses, methods, computer readable medium, and circuits for ordering services in a service chain comprising: receiving, at an edge router, one or more data packets; determining, at the edge router, a sequence order of service chain elements for the one or more data packets based upon an established sequence, the sequence order modifies the established sequence to performing an altering service that alters a payload of the one or more packets prior to one or more remaining services that inspect the one or more packets; transmitting and receiving, by the edge router in the sequence order, the one or more data packets to and from the service chain elements; transmitting, by the edge router, the one more data packets to a destination after a last of the service chain elements has been performed.

### FIELD

The present disclosure relates generally to service chains for software-defined wide area networks.

### BACKGROUND

Software-defined wide area networks (SD-WANs) are capable of operating in a variety of configurations. SD-WANs allow multiple client devices to connect to other parts of the WAN and the internet. In order to allow communication with an external network, SD-WANs implement a firewall that controls the traffic from an edge device of the SD-WAN.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 illustrates an example of a high-level network architecture in accordance with some examples of the present technology.

FIG. 2 illustrates an example of a network topology in accordance with some examples of the present technology.

FIG. 3 illustrates an example of a diagram showing the operation of a protocol for managing an overlay network in accordance with some examples of the present technology.

FIG. 4 illustrates an example of a diagram showing the operation of virtual private networks for segmenting a network in accordance with some examples of the present technology.

FIG. 5 illustrates an example of a diagram showing the operation of a network in accordance with some examples of the present technology;

FIG. 6 illustrates an example data packet layout in accordance with some examples of the present technology.

FIG. 7 illustrates example flow table entries in accordance with some examples of the present technology.

FIG. 8 illustrates a routine in accordance with some examples of the present technology.

FIG. 9 illustrates an example network device in accordance with some examples of the present technology.

FIG. 10 shows an example of computing system, which can be for example any computing device that can implement components of the system in accordance with some examples of the present technology.

### DESCRIPTION

Various examples of the disclosure are discussed in detail below. While specific implementations are discussed, it should be understood that this is done for illustration purposes only. A person skilled in the relevant art will recognize that other components and configurations may be used without parting from the spirit and scope of the disclosure.

A method outlined herein includes: receiving, at an edge router, one or more data packets; determining, at the edge router, a sequence order of service chain elements for the one or more data packets based upon an established sequence, the sequence order modifies the established sequence to performing an altering service that alters a payload of the one or more packets prior to one or more remaining services that inspect the one or more packets; transmitting and receiving, by the edge router in the sequence order, the one or more data packets to and from the service chain elements; transmitting, by the edge router, the one more data packets to a destination after a last of the service chain elements has been performed.

A system is also outlined herein that includes an edge router of a network, the edge router including a processor in communication with a memory and a network interface, the memory including instructions executable by the processor to: receive one or more data packets; determine a sequence order of service chain elements for the one or more data packets based upon an established sequence, the sequence order modifies the established sequence to performing an altering service that alters a payload of the one or more packets prior to one or more remaining services that inspect the one or more packets; transmit and receive, by the edge router in the sequence order, the one or more data packets to and from the service chain elements; transmit, by the edge router, the one more data packets to a destination after a last of the service chain elements has been performed.

The present disclosure also outlines a non-transitory computer-readable medium having embodied thereon a program executable by a processor to perform a method for facilitating service chain sharing in an SD-WAN network, the method including: receive one or more data packets; determine a sequence order of service chain elements for the one or more data packets based upon an established sequence, the sequence order modifies the established sequence to performing an altering service that alters a payload of the one or more packets prior to one or more remaining services that inspect the one or more packets; transmit and receive, by the edge router in the sequence order, the one or more data packets to and from the service chain elements; transmit, by the edge router, the one more data packets to a destination after a last of the service chain elements has been performed.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

SD-WAN (Software-Defined Wide Area Network) services are commonly deployed across a plurality of different “branches” of an SD-WAN, where each “branch” can represent a site (e.g., an office) of an interconnected network. SD-WANs can use Virtual Private Network segments and service chain elements such as firewalls, data compression, load balancing, intrusion detection and prevention, and/or many other services. The disclosed technology addresses the need in the art for systems and methods to provide the services in an order to optimize the services implementation and configuration

The detailed description set forth below is intended as a description of various configurations of examples and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

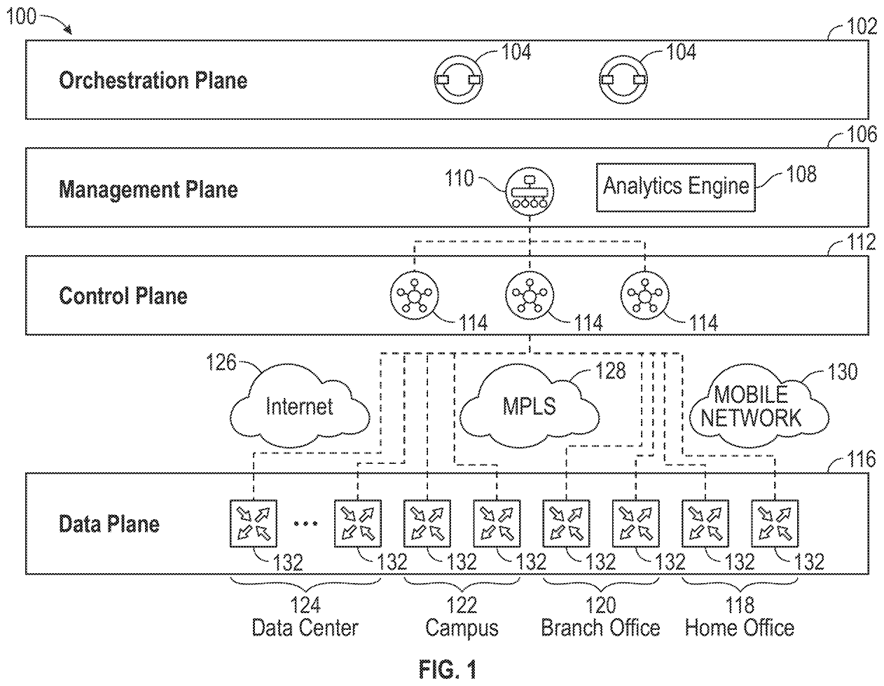

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other examples may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of data planes 116 (e.g., switches, routers, etc.) in an overlay network. The orchestration plane 102 can include one or more physical or virtual network orchestrator appliance(s) 104. The network orchestrator appliance(s) 104 can perform the initial authentication of the data planes 116 and orchestrate connectivity between devices of the control plane 112 and the data plane 116. In some examples, the network orchestrator appliance(s) 104 can also enable communication of devices located behind Network Address Translation (NAT). In some examples, physical or virtual Cisco® SD-WAN vBond appliances can operate as the network orchestrator appliance(s) 104.

The management plane 106 can be responsible for central configuration and monitoring of a network. The management plane 106 can include one or more physical or virtual network management appliance(s) 110, and can in some examples include an analytics engine 108. In some examples, the network management appliance(s) 110 can provide centralized management of the network via a graphical user interface to enable a user to monitor, configure, and maintain the data planes 116 and links (e.g., internet transport network 126, MPLS network 128, 4G/Mobile network 130) in an underlay and overlay network. The network management appliance(s) 110 can support multi-tenancy and enable centralized management of logically isolated networks associated with different entities (e.g., enterprises, divisions within enterprises, groups within divisions, etc.). Alternatively or in addition, the network management appliance(s) 110 can be a dedicated network management system for a single entity. In some examples, physical or virtual Cisco® SD-WAN vManage appliances can operate as the network management appliance(s) 110.

The control plane 112 can build and maintain a network topology and make decisions on where traffic flows. The control plane 112 can include one or more physical or virtual network control appliance(s) 114. The network control appliance(s) 114 can establish secure connections to each data plane 116 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some examples, the network control appliance(s) 114 can operate as route reflectors. The network control appliance(s) 114 can also orchestrate secure connectivity in the data plane 116 between and among the data planes 116. For example, in some examples, the network control appliance(s) 114 can distribute crypto key information among the data planes 116. This can allow the network to support a secure network protocol or application (e.g., Internet Protocol Security (IPSec), TRANSPORT Layer Security (TLS), Secure Shell (SSH), etc.) without Internet Key Exchange (IKE) and enable scalability of the network. In some examples, physical or virtual Cisco® SD-WAN vSmart controllers can operate as the network control appliance(s) 114.

The data plane 116 can be responsible for forwarding packets based on decisions from the control plane 112. The data plane 116 can include the data planes 116, which can be physical or virtual edge network devices. The data planes 116 can operate at the edges various network environments of an organization, such as in one or more data center(s) 124, campus network(s) 122, branch office network(s) 120, home office network(s) 118, and so forth, or in the cloud (e.g., Infrastructure as a Service (IaaS), Platform as a Service (PaaS), SaaS, and other cloud service provider networks). The data planes 116 can provide secure data plane connectivity among sites over one or more WAN TRANSPORTs, such as via one or more internet transport networks 126 (e.g., Digital Subscriber Line (DSL), cable, etc.), MPLS networks 128 (or other private packet-switched network (e.g., Metro Ethernet, Frame Relay, Asynchronous Transfer Mode (ATM), etc.), mobile networks 130 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The data planes 116 can be responsible for traffic forwarding, security, encryption, quality of service (QOS), and routing (e.g., BGP, OSPF, etc.), among other tasks. In some examples, physical or virtual Cisco® SD-WAN vEdge routers can operate as the data planes 116.

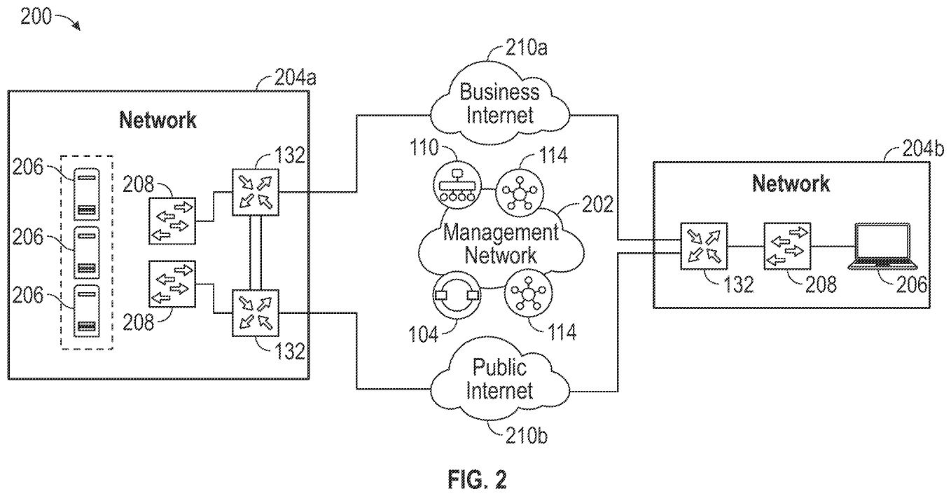

FIG. 2 illustrates an example of a network topology 200 for showing various aspects of the network architecture 100. The network topology 200 can include a Management network 202, a pair of network sites 204A and 204B (also referred to herein as “sites”, and collectively, 204) (e.g., the data center(s) 124, the campus network(s) 122, the branch office network(s) 120, the home office network(s) 118, cloud service provider network(s), etc.), and a pair of Internet transport networks (Business internet 210a and public internet 210b, collectively, 210). The Management network 202 can include one or more network orchestrator appliance(s) 104, one or more network management appliance(s) 110, and one or more network control appliance(s) 114. Although the Management network 202 is shown as a single network in this example, one of ordinary skill in the art will understand that each element of the Management network 202 can be distributed across any number of networks and/or be co-located with the sites 204. In this example, each element of the Management network 202 can be reached through either Internet transport network 210.

Each site can include one or more endpoints 206 connected to one or more site network devices 208. The endpoints 206 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 206 can also include Internet of Things (IOT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

The site network devices 208 can include physical or virtual switches, routers, and other network devices. Although the site 204A is shown including a pair of site network devices and the site 204B is shown including a single site network device in this example, the site network devices 208 can comprise any number of network devices in any network topology, including multi-tier (e.g., core, distribution, and access tiers), spine-and-leaf, mesh, tree, bus, hub and spoke, and so forth. For example, in some examples, one or more data center networks may implement the Cisco® Application Centric Infrastructure (ACI) architecture and/or one or more campus networks may implement the Cisco® Software Defined Access (SD-Access or SDA) architecture. The site network devices 208 can connect the endpoints 206 to one or more edge network devices 132, and the edge network devices 132 can be used to directly connect to the internet transport networks (e.g., Business internet 210a and public internet 210b).

In some examples, “color” can be used to identify an individual WAN transport network, and different WAN transport networks may be assigned different colors (e.g., MPLS, private1, biz-internet, metro-ethernet, LTE, etc.). In this example, the network topology 200 can utilize a color called “biz-internet” for one Internet transport network (Business internet 210a) and a color called “public-internet” for another Internet transport network (public internet 210b).

In some examples, each edge network device 132 can form a Datagram TRANSPORT Layer Security (DTLS) or TLS control connection to the network control appliance(s) 114 and connect to any network control appliance 114 over each internet transport network (e.g., Business internet 210a and public internet 210b). In some examples, the edge network devices 132 can also securely connect to edge network devices in other sites via IPSec tunnels. In some examples, the BFD protocol may be used within each of these tunnels to detect loss, latency, jitter, and path failures.

On the edge network devices 132, color can be used help to identify or distinguish an individual WAN TRANSPORT tunnel (e.g., no same color may be used twice on a single edge network device). Colors by themselves can also have significance. For example, the colors metro-ethernet, MPLS, and private1, private2, private3, private4, private5, and private6 may be considered private colors, which can be used for private networks or in places where there is no NAT addressing of the TRANSPORT IP endpoints (e.g., because there may be no NAT between two endpoints of the same color). When the edge network devices 132 use a private color, they may attempt to build IPSec tunnels to other edge network devices using native, private, underlay IP addresses. The public colors can include 3 g, biz, internet, blue, bronze, custom1, custom2,custom3, default, gold, green, LTE, public-internet, red, and silver. The public colors may be used by the edge network devices 132 to build tunnels to post-NAT IP addresses (if there is NAT involved). If the edge network devices 132 use private colors and need NAT to communicate to other private colors, the carrier setting in the configuration can dictate whether the edge network devices 132 use private or public IP addresses. Using this setting, two private colors can establish a session when one or both are using NAT.

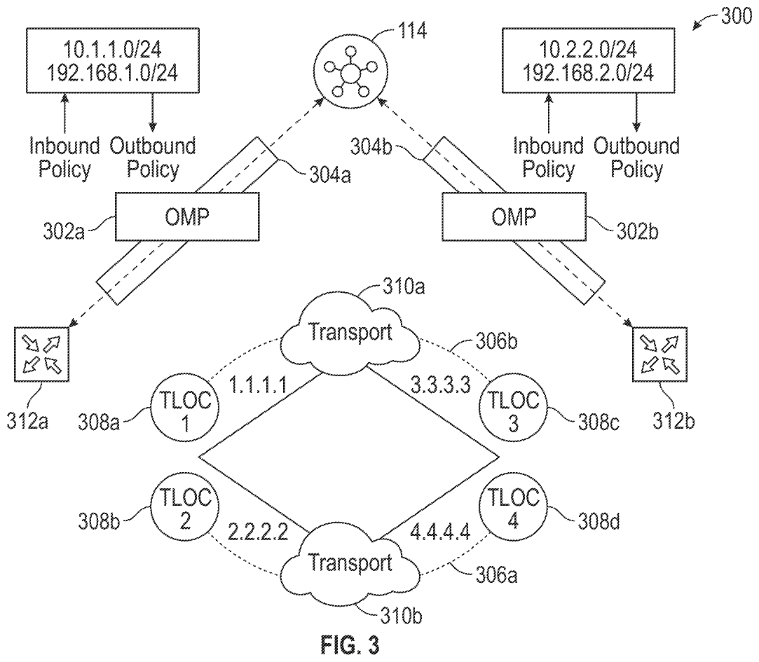

FIG. 3 illustrates an example of a diagram 300 showing the operation of OMP, which may be used in some examples to manage an overlay of a network (e.g., the network architecture 100). In this example, OMP messages 302A and 302B (collectively, 302) may be transmitted back and forth between the network control appliance 114 and Edge Network Device edge network devices 312a and 312b (which can each be an edge network device 132 of FIG. 1), respectively, where control plane information, such as route prefixes, next-hop routes, crypto keys, policy information, and so forth, can be exchanged over respective secure DTLS or TLS connections 304A and 304B. The network control appliance 114 can operate similarly to a route reflector. For example, the network control appliance 114 can receive routes from the edge network devices 312a and 312b, process and apply any policies to them, and advertise routes to other edge network devices in the overlay. If there is no policy defined, the edge network devices 312a and 312b may behave in a manner similar to a full mesh topology, where each edge network device 312a or 312b can connect directly to another edge network device at another site and receive full routing information from each site.

OMP can advertise three types of routes:
OMP routes, which can correspond to prefixes that are learned from the local site, or service side, of the edge network device 312a or 312b. The prefixes can be originated as static or connected routes, or from within, for example, the OSPF or BGP protocols, and redistributed into OMP so they can be carried across the overlay. OMP routes can advertise attributes such as TRANSPORT location (TLOC) information (which can similar to a BGP next-hop IP address) and other attributes such as origin, originator, preference, site identifier, tag, and virtual private network (VPN). An OMP route may be installed in the forwarding table if the TLOC to which it points is active.
TLOC routes, which can correspond to logical tunnel termination points on the edge network device 312a or 312b that connect into Transport network 310a or 310b (which can each be an internet transport network such as internet transport network 126 of FIG. 1). In some examples, a TLOC route can be uniquely identified and represented by a three-tuple, including an IP address, link color, and encapsulation (e.g., Generic Routing Encapsulation (GRE), IPSec, etc.). In addition to system IP address, color, and encapsulation, TLOC routes can also carry attributes such as TLOC private and public IP addresses, carrier, preference, site identifier, tag, and weight. In some examples, a TLOC may be in an active state on a particular edge network device 312a or 312b when an active BFD session is associated with that TLOC.
Service routes, which can represent services (e.g., firewall, distributed denial of service (DDoS) mitigator, load balancer, intrusion prevent system (IPS), intrusion detection systems (IDS), WAN optimizer, etc.) that may be connected to the local sites of the edge network devices 312a and 312b and accessible to other sites for use with service insertion. In addition, these routes can also include VPNs; the VPN labels can be sent in an update type to tell the network control appliance 114 what VPNs are serviced at a remote site.

In the example of FIG. 3, OMP is shown running over the DTLS/TLS tunnels 304a and 304b established between the edge network devices 312a and 312b and the network control appliance 114. In addition, the diagram 300 shows an IPSec tunnel 306A established between TLOC 308A and 308C over the (WAN) Transport network 310a and an IPSec tunnel 306B established between TLOC 308B and TLOC 308D over the (WAN) Transport network 310b. Once the IPSec tunnels 306A and 306B are established, BFD can be enabled across each of them.

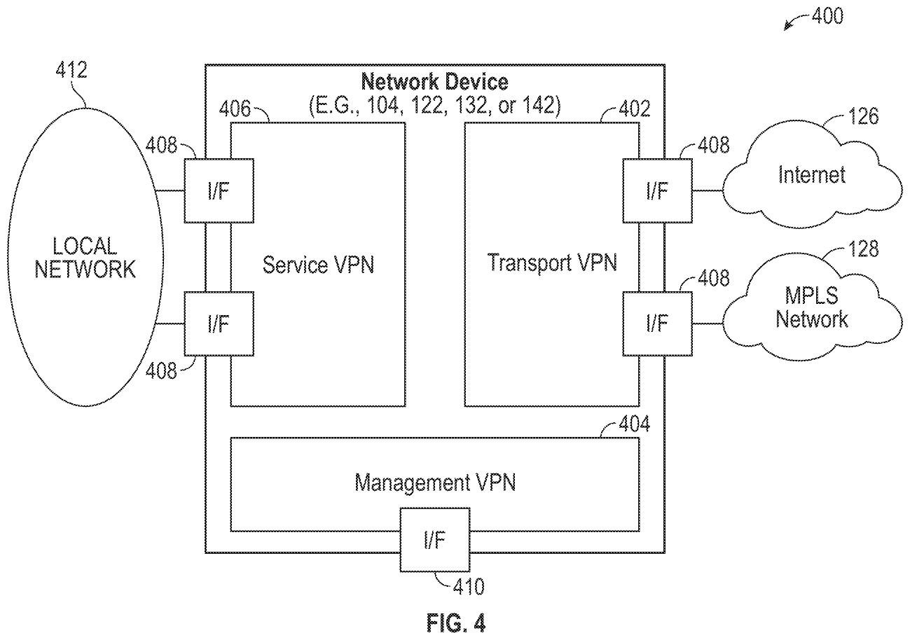

FIG. 4 illustrates an example of a diagram 400 showing the operation of VPNs, which may be used in some examples to provide segmentation for a network (e.g., the network architecture 100). VPNs can be isolated from one another and can have their own forwarding tables. An interface or sub-interface can be explicitly configured under a single VPN and may not be part of more than one VPN. Labels may be used in OMP route attributes and in the packet encapsulation, which can identify the VPN to which a packet belongs. The VPN number can be a four-byte integer with a value from 0 to 65530. In some examples, the network orchestrator appliance(s) 104, network management appliance(s) 110, network control appliance(s) 114, and/or edge network devices 132 can each include a transport VPN 402 (e.g., VPN number 0) and a Management VPN 404. The transport VPN 402 can include one or more physical or virtual network interfaces (I/F 408) that respectively connect to WAN TRANSPORT networks (e.g., the MPLS network 128 and the Internet transport network 126). Secure DTLS/TLS connections to the network control appliance(s) 114 or between the network control appliance(s) 114 and the network orchestrator appliance(s) 104 can be initiated from the transport VPN 402. In addition, static or default routes or a dynamic routing protocol can be configured inside the transport VPN 402 to get appropriate next-hop information so that the control plane 112 may be established and IPSec tunnels (not shown) can connect to remote sites.

The Management VPN 404 can carry out-of-band management traffic to and from the network orchestrator appliance(s) 104, network management appliance(s) 110, network control appliance(s) 114, and/or edge network devices 132 over a network interface (I/F 410). In some examples, the Management VPN 404 may not be carried across the overlay network.

In addition to the transport VPN 402 and the Management VPN 404, the network orchestrator appliance(s) 104, network management appliance(s) 110, network control appliance(s) 114, or edge network devices 132 can also include one or more service-side VPNs (Service VPN 406). The Service VPN 406 can include one or more physical or virtual network interfaces (I/Fs 408) that connect to one or more local-site networks (Local Network 412) and carry user data traffic. The Service VPN 406 can be enabled for features such as OSPF or BGP, Virtual Router Redundancy Protocol (VRRP), QOS, traffic shaping, policing, and so forth. In some examples, user traffic can be directed over IPSec tunnels to other sites by redistributing OMP routes received from the network control appliance(s) 114 at the Local Network 412 into the service-side VPN routing protocol. In turn, routes from the Local Network 412 can be advertised to other sites by advertising the service VPN routes into the OMP routing protocol, which can be sent to the network control appliance(s) 114 and redistributed to other edge network devices 132 in the network. Although the network interfaces (I/Fs 408 and 410) are shown to be physical interfaces in this example, one of ordinary skill in the art will appreciate that the interfaces in the transport and service VPNs can also be sub-interfaces instead.

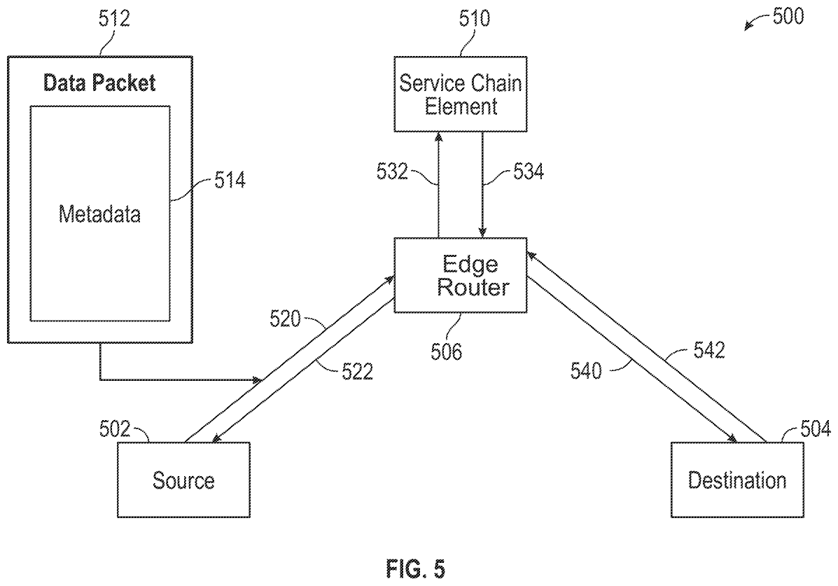

FIG. 5 shows an SD-WAN network 500 having an edge router 506 that facilitates establishment of a (new) first flow upon receipt of a data packet 512 from a source 502 and applies service chain functionalities at a service chain element 510, and forwards the data packet 512 to a destination 504. The data packet 512 can include associated metadata 514. The edge router 506 receives the data packet 512 belonging to a first flow from the source 502 to be transmitted to the destination 504, and extracts flow information of the first flow from the data packet 512 and stores the flow information in a flow table. The edge router 506 then transmits 532 the data packet 512 to the service chain element 510. Upon return 534 of the data packet 512 from the service chain element 510, the edge router 506 uses the flow information to transmit the data packet 512 to a next one of the service chain elements. This process can repeat until all of the service chain elements in the flow has been satisfied. The edge router 506 can forward the data packet 512 to the destination 504. In another example a firewall can be located between the edge router 506 and a destination 504. The flow is illustrated in a first direction 520 from the source to edge router 506 and hub note in a first direction 540 to the destination. The flow can also be described more fully by a sequence order. The sequence order can be based upon an established sequence. The established sequence can be preprogramed. In other examples, the established sequence can be set by the system and/or an operator. In at least one example, the establish sequence is partially operator defined.

In another example, the flow direction can be in a second direction 522, 542. In the second flow direction, the device marked as destination 504 can be sending data or sending a response to source 502. The edge router 506 receives the data packet 512 belonging to a second flow from the destination 504 to be transmitted to the source 502, and extracts flow information of the first flow from the data packet 512 and stores the flow information in a flow table. The edge router 506 then transmits 532 the data packet 512 to the service chain element 510. Upon return 534 of the data packet 512 from the service chain element 510, the edge router 506 uses the flow information to transmit the data packet 512 to a next one of the service chain elements. This process can repeat until all of the service chain elements in the flow has been satisfied. The edge router 506 can forward the data packet 512 to the source 502. The flow can also be described more fully by a sequence order. The sequence order can be based upon an established sequence, but performed in the reverse order. In another example, the sequence order can be modified such that the sequence order in the first direction order is opposite of the sequence order in a second direction order, except for the altering services are performed prior to other parts of the sequence order.

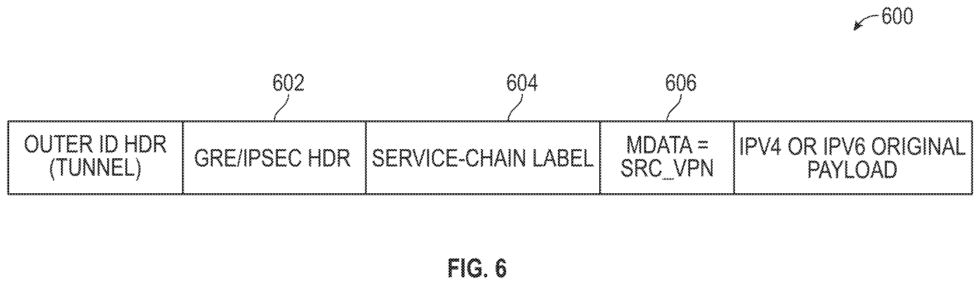

FIG. 6 shows a sample packet format for a data packet 600 that can be carried between the source 502 (FIG. 5) and the edge router 506 with additional information being carried within metadata 514 of the data packet 600. The data packet 600 can include packet tuple info 602 (e.g., present within a GRE/IPSec header), service chain info 604 (e.g., as a “service-chain label”), VPN segment Info 606 (e.g., as “MDATA=SRC_VPN”). The edge router 506 can use this information to extract flow information for the data packet 600. For transmitting the data packet 512 to the service chain element 510, the edge router 506 may remove the VPN segment Info 606 about the source VPN segment (e.g., first VPN segment) before sending forward to the service chain element 510. In some examples, the edge router 506 can re-format or otherwise update the header of the (outgoing) data packet to be suitable for handling by the service chain element 510. Additionally, the edge router 506 as described can determine the sequence order from the established sequence order.

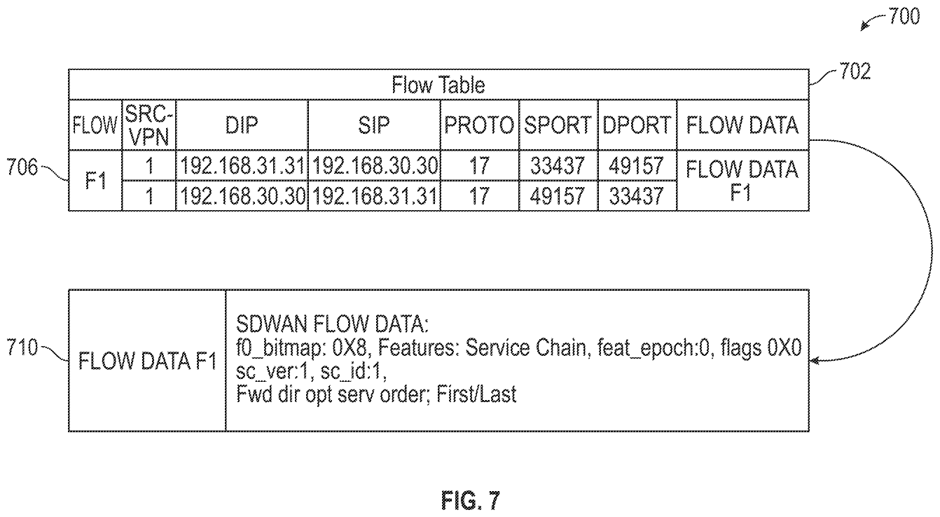

FIG. 7 is a diagram 700 showing example flow table and flow information entries that may be recorded within a flow table by the edge router 506. In particular, FIG. 7 shows an flow table 702 that shows a first flow table entry 706.

The flow table 702 includes packet tuple information for data packets (e.g., data packets 512) associated with each respective flow that the edge router 506 receives from the source 502 and that need to be sent to the service chain element 510. The packet tuple information can include, but is not limited to: flow identifiers, source VPN info (SRC-VPN), a destination IP address (DIP), a source IP address (SIP), source and destination port information (SPORT and DPORT), and flow information.

In the example, the first outgoing flow table entry 706 includes first flow information 710 (flow data for F1) about a first flow (F1).

FIG. 7 also shows example entries for the first flow information 710

Configuration 1 below shows a detailed example of a service-chain entry (which can describe flow information) including two different sequence numbers. This specifies the service orders as IPS and FW for both directions of the service-chain flow.

### Configuration 1

service-chain SC1
service-chain-vrf 100
service IPS
sequence 1 [symbol] Sequence number
service-transport-ha-pair 1
active tx ipv4 1.1.1.1 interface gel
service FW
sequence 2 [symbol] Sequence number
service-transport-ha-pair 1
active tx ipv4 2.2.2.2 interface ge2

Configuration 2 below shows a detailed example of a service-chain entry (with flow information) including three different sequences with a specified sequence number. This defines the forward direction order of services such as IPS, FW, and netsvc1. For a reverse direction of the service order it is netsvc1, FW, and IPS. This allows for control over the service chain order in each direction of flow.

### Configuration 2

service-chain SC1
service-chain-vrf 100
service IPS
sequence 1
service-transport-ha-pair 1
active tx ipv4 1.1.1.1 interface gel
service FW
sequence 2
service-transport-ha-pair 1
active tx ipv4 2.2.2.2 interface ge2
service netsvc1
sequence 3
service-transport-ha-pair 1
active tx ipv4 3.3.3.3 interface ge3
reverse-dir-svc-order sequence 3 sequence 2 sequence 1 [symbol] reverse direction order.

Configuration 3 below shows a detailed example of a service-chain entry (which includes flow information) including two different services without a specified sequence number. Additionally, one of the services is a packet altering service. The case service order is determined based on packet parsing to determine if the packet alteration service should be executed first or last for the forward direction. Additionally, a determination is made if the packet alteration service should be executed first or last for the reverse direction. This allows for control over the service chain order in order to allow altering of the flow.

### Configuration 3

service-chain SC1
service-chain-vrf 100
service AppQoE
service-type/attribute packet-alter
service-transport-ha-pair 1
active tx ipv4 1.1.1.1 interface gel
service FW
service-transport-ha-pair 1
active tx ipv4 2.2.2.2 interface ge2

Multiple data packets can belong to the same flow. Upon receipt of a data packet that indicates a new flow (e.g., a flow that has not been previously recorded within the flow table), the edge router 506 creates a new entry with flow information for the data packet. For subsequent data packets belonging to the same flow, the edge router 506 recognizes that they belong to the same flow and will associate each subsequent data packet with this flow.

The present disclosure allows for the attaching of services in a service chain under a specific sequence number. The sequence number can be from lower numbers to higher numbers that specify the service chain execution order for the forward direction of the flow. If no further specific configuration is implemented, then the same order can be executed for the reverse direction of flow. In other examples, the reverse direction of flow can have a specific configuration such as illustrated in Table 2. In other configurations, the system can be configuration to inspect and/or alter the packet payload. In altering the packet contents, optimization service can be implemented to detect if the traffic is compressed or uncompressed. Depending on the state of the compression, the optimization service can be executed as the last service or the first service.

The optimization service order can be determined such that the optimization service is part of the service chain. The optimization service can be identified based upon a name of the service or based on whether the service is configured to operate with a service attribute that differentiates the optimization service from other types of services. If a service is compression/decompression, the two end nodes where the compression and decompression happen require bidirectional capability that is negotiated. For example, the negotiation can happen using TCP option 0x21 in TCP SYN/SYN-ACK packets. The present disclosure can identify if the receiving device is attempting to perform any data redundance elimination (DRE) compression/decompression. If the receiving device is configured for DRE, then other services are executed prior to compression and if a receiving device is going to decompress then other services are executed after decompression. Alternatively, the metadata in the packet can indicate if the packet is compressed and needs decompression prior to executing other services in the service chain.

In at least one example, a service chain database can be maintained at a data plane, which is inside the edge device. The data plane can store the information about configured services and service sequence. The service sequence that is stored can include a forward and/or reverse flow direction. As used herein, forward flow direction is the flow that is defined by the first packet direction of any new flow.

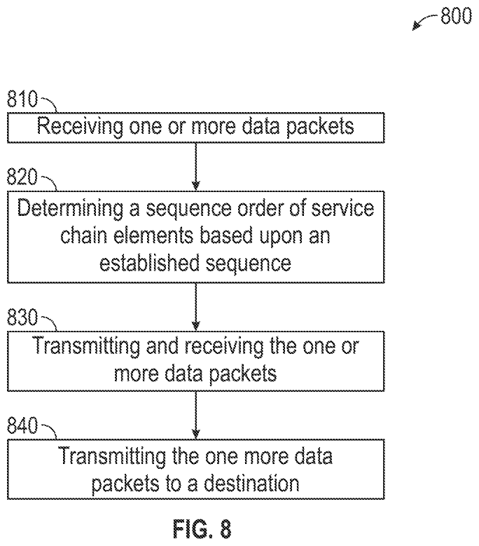

FIG. 8 illustrates an example method 800 for ordering services in a service chain. The service chain can be part of the networks presented in FIGS. 1, 2, 3 and/or 5.

According to some examples, the method 800 includes receiving, at an edge router, one or more data packets at block 810. As described above, a source can send the one or more data packets to the edge router. The edge router can be configured to receive the data packets including the associated metadata. The data packets can include one or more additional pieces of information as described above. In a first direction, the source can be described to the one sending the data packet. This can also be referred to as a forward direction. The forward and first direction denotation is for easy of discussion. The order of which direction a particular data packet is sent depends on a variety of factors and the data packet can vary in the different directions, but is simply referred to as a data packet herein.

According to some examples, the method 800 includes determining, at the edge router, a sequence order of service chain elements for the one or more data packets based upon an established sequence at block 820. In at least one example, the sequence order modifies the established sequence to performing an altering service that alters a payload of the one or more packets prior to one or more remaining services that inspect the one or more packets.

In at least one example, the established sequence is at least partially operator defined. In another example, the sequence order is performed through an automatic detection operation. In other examples, the sequence order can be performed through an automatic detection operation based on a partially operator defined order.

Additionally, the established sequence can have a first direction order that is used for sending packets and a second direction order that is used for receiving packets. In at least one example, the established sequence for the first direction order is different from the sequence order in the second direction order. In another example, the established sequence for the first direction order is the same as the sequence order in the second direction order. In yet another example, the sequence order in a first direction order is opposite of the sequence order in a second direction order, except for the altering services are performed prior to other parts of the sequence order. In still another example, the sequence order in a first direction order is the same as the sequence order in a second direction order, except for the altering services are performed prior and/or after other parts of the sequence order.

According to some examples, the method 800 includes transmitting and receiving, by the edge router in the sequence order, the one or more data packets to and from the service chain elements at block 830. The method can also include performing, by the service chain element, each of one or more services on the one or more data packets. In at least one example, the repeated forwarding of the one or more data packets can be referred to as hair pinning the data packet with the edge router.

According to some examples, the method 800 includes transmitting, by the edge router, the one more data packets to a destination after a last of the service chain elements has been performed at block 840. While the illustrated example is in terms of sending the data packet from a source inside the SDWAN to a destination outside the SDWAN, the implementation can also be within in the reverse direction.

### Network Device(s) and Computing System

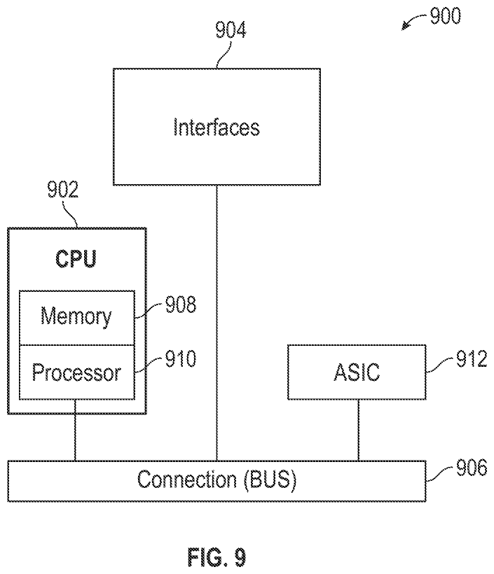

FIG. 9 illustrates an example network device 900 suitable for performing switching, routing, load balancing, and other networking operations. The example network device 900 can be implemented as switches, routers (e.g., edge network devices 132), nodes, metadata servers, load balancers, client devices, and so forth.

Network device 900 includes a central processing unit (CPU 902), interface(s) 904, and a bus connection 906 (e.g., a PCI bus). When acting under the control of appropriate software or firmware, the CPU 902 is responsible for executing packet management, error detection, and/or routing functions. The CPU 902 preferably accomplishes all these functions under the control of software including an operating system and any appropriate applications software. CPU 902 may include one or more processors 910, such as a processor from the INTEL X86 family of microprocessors. In some cases, processor 910 can be specially designed hardware for controlling the operations of network device 900. In some cases, a memory 908 (e.g., non-volatile RAM, ROM, etc.) also forms part of CPU 902. However, there are many different ways in which memory 908 could be coupled to the system.

The interface(s) 904 are typically provided as modular interface cards (sometimes referred to as “line cards”). Generally, they control the sending and receiving of data packets over the network and sometimes support other peripherals used with the network device 900. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., CPU 902) to efficiently perform routing computations, network diagnostics, security functions, etc.

Although the system shown in FIG. 9 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 900.

Regardless of the network device's configuration, it may employ one or more memories or memory modules (including memory 908) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 908 could also hold various software containers and virtualized execution environments and data. Memory 908 can also include instructions for executing aspects of routine 800 outlined herein with respect to FIG. 5 and/or routine 800 of FIG. 8.

The network device 900 can also include an application-specific integrated circuit (ASIC) 912, which can be configured to perform routing and/or switching operations. The ASIC 912 can communicate with other components in the network device 900 via the bus connection 906, to exchange data and signals and coordinate various types of operations by the network device 900, such as routing, switching, and/or data storage operations, for example.

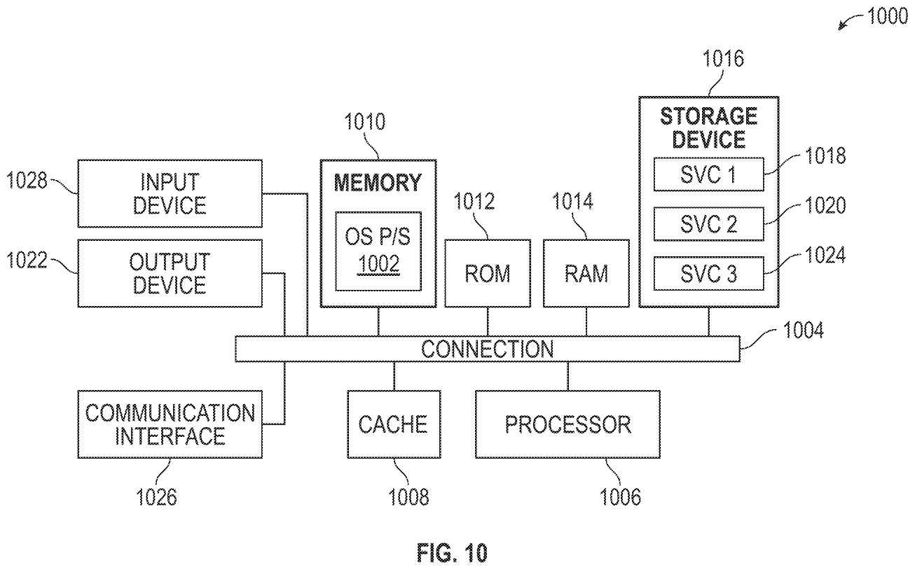

FIG. 10 shows an example of computing system 1000, which can be for example any computing device for assisting with the functionalities of network devices (e.g., such as managing and storing information within routing tables) or any component thereof in which the components of the system are in communication with each other using connection 1004. Connection 1004 can be a physical connection via a bus, or a direct connection into processor 1006, such as in a chipset architecture. Connection 1004 can also be a virtual connection, networked connection, or logical connection.

In some examples computing system 1000 is a distributed system in which the functions described in this disclosure can be distributed within a datacenter, multiple datacenters, a peer network, etc. In some examples, one or more of the described system components represents many such components each performing some or all of the function for which the component is described. In some examples, the components can be physical or virtual devices.

Example system 1000 includes at least one processing unit (CPU or processor) 1006 and connection 1004 that couples various system components including system memory 1010 which can include operating system processes/services 1002 embodied thereon, such as read only memory (ROM) 1012 and random access memory (RAM) 1014 to processor 1006. Computing system 1000 can include a cache 1008 of high-speed memory connected directly with, in close proximity to, or integrated as part of processor 1006.

Processor 1006 can include any general purpose processor and a hardware service or software service, such as services 1018, 1020, and 1024 stored in storage device 1016, configured to control processor 1006 as well as a special-purpose processor where software instructions are incorporated into the actual processor design. Processor 1006 may essentially be a completely self-contained computing system, containing multiple cores or processors, a bus, memory controller, cache, etc. A multi-core processor may be symmetric or asymmetric.

To enable user interaction, computing system 1000 includes an input device 1028, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1026, which can generally govern and manage the user input and system output. There is no restriction on operating on any particular hardware arrangement and therefore the basic features here may easily be substituted for improved hardware or firmware arrangements as they are developed.

Storage device 1016 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1016 can include software services, servers, services, etc., that when the code that defines such software is executed by the processor 1006, it causes the system to perform a function. In some examples, a hardware service that performs a particular function can include the software component stored in a computer-readable medium in connection with the necessary hardware components, such as processor 1006, connection 1004, output device 1022, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program, or a collection of programs that carry out a specific function. In some examples, a service can be considered a server. The memory can be a non-transitory computer-readable medium.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer- executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Aspect 1. A method for ordering services in a service chain comprising: receiving, at an edge router, one or more data packets; determining, at the edge router, a sequence order of service chain elements for the one or more data packets based upon an established sequence, the sequence order modifies the established sequence to performing an altering service that alters a payload of the one or more packets prior to one or more remaining services that inspect the one or more packets; transmitting and receiving, by the edge router in the sequence order, the one or more data packets to and from the service chain elements; transmitting, by the edge router, the one more data packets to a destination after a last of the service chain elements has been performed.

Aspect 2. The method of Aspect 1, wherein the established sequence is at least partially operator defined.

Aspect 3. The method of any of Aspects 1 to 2, wherein the established sequence has a first direction order that is used for sending packets and a second direction order that is used for receiving packets.

Aspect 4. The method of any of Aspects 1 to 3, wherein the established sequence for the first direction order is different from the sequence order in the second direction order.

Aspect 5. The method of any of Aspects 1 to 4, wherein the sequence order in a first direction order is opposite of the sequence order in a second direction order, except for the altering services are performed prior to other parts of the sequence order.

Aspect 6. The method of any of Aspects 1 to 5, wherein the sequence order is performed through an automatic detection operation.

Aspect 7. The method of any of Aspects 1 to 6, further comprising: performing, by the service chain element, each of one or more services on the one or more data packets.

Aspect 8. A system includes a storage (implemented in circuitry) configured to store instructions and a processor. The processor configured to execute the instructions and cause the processor to: receive, at an edge router, one or more data packets; determine, at the edge router, a sequence order of service chain elements for the one or more data packets based upon an established sequence, the sequence order modifies the established sequence to performing an altering service that alters a payload of the one or more packets prior to one or more remaining services that inspect the one or more packets; transmit and receive, by the edge router in the sequence order, the one or more data packets to and from the service chain elements; transmit, by the edge router, the one more data packets to a destination after a last of the service chain elements has been performed.

Aspect 9. The system of Aspect 8, wherein the established sequence is at least partially operator defined.

Aspect 10. The system of any of Aspects 8 to 9, wherein the established sequence has a first direction order that is used for sending packets and a second direction order that is used for receiving packets.

Aspect 11. The system of any of Aspects 8 to 10, wherein the established sequence for the first direction order is different from the sequence order in the second direction order.

Aspect 12. The system of any of Aspects 8 to 11, wherein the sequence order in a first direction order is opposite of the sequence order in a second direction order, except for the altering services are performed prior to other parts of the sequence order.

Aspect 13. The system of any of Aspects 8 to 12, wherein the sequence order is performed through an automatic detection operation.

Aspect 14. The system of any of Aspects 9 to 13, wherein the processor is configured to perform, by the service chain element, each of one or more services on the one or more data packets.

Aspect 15. A computer readable medium comprising instructions using a computer system. The computer includes a memory (e.g., implemented in circuitry) and a processor (or multiple processors) coupled to the memory. The processor (or processors) is configured to execute the computer readable medium and cause the processor to: receive, at an edge router, one or more data packets; determine, at the edge router, a sequence order of service chain elements for the one or more data packets based upon an established sequence, the sequence order modifies the established sequence to performing an altering service that alters a payload of the one or more packets prior to one or more remaining services that inspect the one or more packets; transmit and receive, by the edge router in the sequence order, the one or more data packets to and from the service chain elements; transmit, by the edge router, the one more data packets to a destination after a last of the service chain elements has been performed.

Aspect 16. The computer readable medium of Aspect 15, wherein the established sequence is at least partially operator defined.

Aspect 17. The computer readable medium of any of Aspects 15 to 16, wherein the established sequence has a first direction order that is used for sending packets and a second direction order that is used for receiving packets.

Aspect 18. The computer readable medium of any of Aspects 15 to 17, wherein the established sequence for the first direction order is different from the sequence order in the second direction order.

Aspect 19. The computer readable medium of any of Aspects 15 to 18, wherein the sequence order in a first direction order is opposite of the sequence order in a second direction order, except for the altering services are performed prior to other parts of the sequence order.

Aspect 20. The computer readable medium of any of Aspects 15 to 19, wherein the sequence order is performed through an automatic detection operation.

Aspect 21. The computer readable medium of any of Aspects 15 to 20, wherein the processor is configured to perform, by the service chain element, each of one or more services on the one or more data packets.

What is claimed is:

1. A method for ordering services in a service chain comprising:
receiving, at an edge router, one or more data packets;
determining, at the edge router, a sequence order of service chain elements for the one or more data packets based upon an established sequence, the sequence order modifies the established sequence to performing an altering service that alters a payload of the one or more packets prior to one or more remaining services that inspect the one or more packets;
transmitting and receiving, by the edge router in the sequence order, the one or more data packets to and from the service chain elements; transmitting, by the edge router, the one more data packets to a destination after a last of the service chain elements has been performed.

2. The method of claim 1, wherein the established sequence is at least partially operator defined.

3. The method of claim 1, wherein the established sequence has a first direction order that is used for sending packets and a second direction order that is used for receiving packets.

4. The method of claim 3, wherein the established sequence for the first direction order is different from the sequence order in the second direction order.

5. The method of claim 4, wherein the sequence order in a first direction order is opposite of the sequence order in a second direction order, except for the altering services are performed prior to other parts of the sequence order.

6. The method of claim 1, wherein the sequence order is performed through an automatic detection operation.

7. The method of claim 1, further comprising: performing, by the service chain element, each of one or more services on the one or more data packets.

8. A system comprising:
a storage configured to store instructions;
a processor configured to execute the instructions and cause the processor to:
receive, at an edge router, one or more data packets;
determine, at the edge router, a sequence order of service chain elements for the one or more data packets based upon an established sequence, the sequence order modifies the established sequence to performing an altering service that alters a payload of the one or more packets prior to one or more remaining services that inspect the one or more packets;
transmit and receive, by the edge router in the sequence order, the one or more data packets to and from the service chain elements;
transmit, by the edge router, the one more data packets to a destination after a last of the service chain elements has been performed.

9. The system of claim 8, wherein the established sequence is at least partially operator defined.

10. The system of claim 8, wherein the established sequence has a first direction order that is used for sending packets and a second direction order that is used for receiving packets.

11. The system of claim 10, wherein the established sequence for the first direction order is different from the sequence order in the second direction order.

12. The system of claim 11, wherein the sequence order in a first direction order is opposite of the sequence order in a second direction order, except for the altering services are performed prior to other parts of the sequence order.

13. The system of claim 8, wherein the sequence order is performed through an automatic detection operation.

14. The system of claim 8, wherein the processor is configured to perform, by the service chain element, each of one or more services on the one or more data packets.

15. A non-transitory computer readable medium comprising instructions, the instructions, when executed by a computing system, cause the computing system to:
receive, at an edge router, one or more data packets;
determine, at the edge router, a sequence order of service chain elements for the one or more data packets based upon an established sequence, the sequence order modifies the established sequence to performing an altering service that alters a payload of the one or more packets prior to one or more remaining services that inspect the one or more packets;
transmit and receive, by the edge router in the sequence order, the one or more data packets to and from the service chain elements;
transmit, by the edge router, the one more data packets to a destination after a last of the service chain elements has been performed.

16. The computer readable medium of claim 15, the established sequence is at least partially operator defined.

17. The computer readable medium of claim 15, the established sequence has a first direction order that is used for sending packets and a second direction order that is used for receiving packets.

18. The computer readable medium of claim 17, the established sequence for the first direction order is different from the sequence order in the second direction order.

19. The computer readable medium of claim 18, the sequence order in a first direction order is opposite of the sequence order in a second direction order, except for the altering services are performed prior to other parts of the sequence order.

20. The computer readable medium of claim 15, the sequence order is performed through an automatic detection operation.
